(19) United States
(12) Patent Application Publication
(10) Pub. No.: US 2026/0221611 A1
(43) Pub. Date: Jul. 30, 2026

(54) BATTERY AND METHOD FOR MANUFACTURING BATTERY

(71) Applicant: Panasonic Intellectual Property Management Co., Ltd., Osaka (JP)

(72) Inventors: RYO SUGAWARA, Hyogo (JP); KAZUHIRO MORIOKA, Osaka (JP)

(21) Appl. No.: 19/574,317

(22) Filed: Mar. 21, 2026

Related U.S. Application Data
(63) Continuation of application No. PCT/JP2024/038750, filed on Oct. 30, 2024.

(30) Foreign Application Priority Data
Dec. 18, 2023 (JP) 2023-212859

(51) Int. Cl. H01M 50/533; H01M 10/0585

(52) U.S. Cl. CPC H01M 50/533; H01M 10/0585

(57) ABSTRACT

A battery of the present disclosure includes a power-generating element and a collector laminated on the power-generating element,. In an area of overlap between the collector and the power-generating element as seen along a direction of lamination of the power-generating element and the collector, a ratio of a second thickness to a first thickness is greater than or equal to 101% and less than or equal to 200%. The first thickness is a thickness of a central part of the collector The second thickness is a maximum thickness of the collector at an end portion thereof.

### BACKGROUND

### 1. Technical Field

The present disclosure relates to a battery and a method for manufacturing a battery.

### 2. Description of the Related Art

Japanese Unexamined Patent Application Publication No. 2000-188099 discloses a method for manufacturing a thin-film battery. This method includes cutting a battery laminate web of a power-generating element with a cutting blade by advancing the cutting blade from the side face direction of the battery laminate web.

International Publication No. 2022/239486 discloses that in a battery cutting process, a battery is cut down while being slid in the length direction of a cutting blade. The battery disclosed in International Publication No. 2022/239486 is provided with a streak-like cut mark that is inclined to the thickness direction of a battery cell.

International Publication No. 2022/270042 discloses a method for manufacturing a battery. This method includes a first cutting step of cutting a laminate including a battery cell at a first cutting position to form a first cut surface and a second cutting step of further cutting the laminate at a second cutting position that is further inward than the first cutting position to form a second cut surface.

### SUMMARY

It is desirable to further improve the reliability of batteries in the conventional technologies.

One non-limiting and exemplary embodiment provides a highly reliable battery and a method for manufacturing a battery.

In one general aspect, the techniques disclosed here feature a battery including a power-generating element and a collector laminated on the power-generating element,. In an area of overlap between the collector and the power generating element as seen along a direction of lamination of the power-generating element and the collector, a ratio of a second thickness to a first thickness is greater than or equal to 101% and less than or equal to 200%. The first thickness is a thickness of a central part of the collector The second thickness is a maximum thickness of the collector at an end portion thereof.

The present disclosure makes it possible to provide a highly reliable battery and a method for manufacturing a battery.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view of a battery according to an embodiment;

FIG. 2 is a side view of the battery according to the embodiment;

FIG. 3 is a cross-sectional view of the battery according to the embodiment;

FIG. 4 is a flow chart showing an example of a method for manufacturing a battery according to an embodiment;

FIG. 5 is a perspective view showing a state that follows the cutting of a laminate;

FIG. 6 is a cross-sectional view of a laminate left by cutting the laminate; and

FIG. 7 is a perspective view for explaining a machining process.

### DETAILED DESCRIPTIONS

### Underlying Knowledge Forming Basis of the Present Disclosure

In enhancing the reliability of a battery including a power-generating element having a positive-electrode layer and a negative-electrode layer, one important quality is to reduce the risk of a short circuit between the positive-electrode layer and the negative-electrode layer in the power-generating element.

A short circuit between the positive-electrode layer and the negative-electrode layer in the power-generating element tends to occur especially at an end portion of the battery. A short circuit between the positive-electrode layer and the negative-electrode layer at the end portion of the battery occurs, for example, due to attachment of foreign bodies, collapse of the layers of the power-generating element, formation of burrs on a collector, or other factors. For example, in a step of cutting and processing a battery into a predetermined size in manufacturing the battery, attachment of chips of the collector, which has electrical conductivity, and an active material layer, and attachment of foreign bodies in the cutting and processing step, burrs on the collector, collapse of the positive-electrode layer and the negative-electrode layer, or other factors may cause a minute electrically conducting path to be formed, with the result that positive and negative electrodes become electrically connected to each other.

The present disclosure was made on the basis of the foregoing findings and provides a highly reliable battery and a method for manufacturing a battery.

### Brief Overview of the Present Disclosure

The following describes, as a brief overview of the present disclosure, examples of a battery and a method for manufacturing a battery according to the present disclosure.

For example, a battery according to a first aspect of the present disclosure includes a power-generating element and a collector laminated on the power-generating element,. In an area of overlap between the collector and the power-generating element as seen along a direction of lamination of the power-generating element and the collector, a ratio of a second thickness to a first thickness is greater than or equal to 101% and less than or equal to 200%. The first thickness is a thickness of a central part of the collector The second thickness is a maximum thickness of the collector at an end portion thereof.

This causes the end portion of the collector to sink into the power-generating element to cover an end face of the power-generating element, making it possible to reduce the risk of collapse of the power-generating element. This makes it possible to reduce the risk of a short circuit between positive and negative electrodes of the power-generating element due to collapse. Further, since the second thickness is less than or equal to 200% of the first thickness, it becomes hard for the collector to make contact with both the positive and negative electrodes of one power-generating element, making it possible to reduce the risk of a short circuit between the positive and negative electrodes by the collector. This makes it possible to enhance the reliability of the battery.

Further, for example, a battery according to a second aspect of the present disclosure may be directed to the battery according to the first aspect, wherein the second thickness is greater than the first thickness by 0.2 μm or greater and 5 μm or less.

This makes it possible to enhance the effect of improvement in reliability by the ratio of the second thickness to the first thickness.

Further, for example, a battery according to a third aspect of the present disclosure may be directed to the battery according to the first or second aspect, wherein in a case where the collector is seen from the end portion, a length of an end face of the collector in the direction of lamination is not constant.

This makes it hard for the collector and the power-generating element to slide in a direction perpendicular to the direction of lamination, making it possible to reduce the risk of delamination of the collector and the power-generating element.

Further, for example, a battery according to a fourth aspect of the present disclosure may be directed to the battery according to any one of the first to third aspects, wherein the end portion of the collector spreads further toward both sides of the direction of lamination than the central part of the collector.

Even in a case where the second thickness is greater than the first thickness, this makes it harder for the positive and negative electrodes of the power-generating element to become short-circuited with each other via the collector, as the end portion of the collector spreads toward both sides of the direction of lamination to become thick.

Further, for example, a battery according to a fifth aspect of the present disclosure may be directed to the battery according to any one of the first to fourth aspects, wherein in a case where the collector is seen from the end portion, the end face of the collector is provided with a linear depressed portion or raised portion, and the linear depressed portion or raised portion forms an angle of 90 degrees with respect to the direction of lamination.

This causes a terminal to engage with the linear depressed portion or raised portion in connecting the terminal to the end face of the collector and makes it hard for the terminal to become misaligned in the direction of lamination, making it possible to reduce the risk of a short circuit between the positive and negative electrodes of the power-generating element via the terminal.

Further, for example, a battery according to a sixth aspect of the present disclosure may be directed to the battery according to any one of the first to fifth aspects, wherein the power-generating element includes a positive-electrode layer, a negative-electrode layer, and a solid electrolyte layer located between the positive-electrode layer and the negative-electrode layer.

In a solid battery having such a solid electrolyte layer, the solid electrolyte layer, as well as the positive-electrode layer and the negative-electrode layer, may collapse; however, covering the power-generating element with the end portion of the collector makes it also possible to reduce the risk of collapse of the solid electrolyte layer.

Further, for example, a method for manufacturing a battery according to a seventh aspect of the present disclosure includes preparing a laminate in which a power-generating element and a collector are laminated and machining an end face of the laminate in a direction at 90 degrees with respect to a direction of lamination of the power-generating element and the collector.

This causes such a minute plastic flow to occur in the tissue of the collector during the machining of the end face of the laminate that the tissue of the collector near the end face escapes in the direction of lamination. This causes the end portion of the collector to project in the direction of lamination, causing the end portion of the collector to become greater in thickness. Further, the tissue of the collector that underwent the plastic flow sinks into the end face of the power-generating element. This makes it possible to manufacture a highly reliable battery having the foregoing structure. Further, since the end face of the laminate is machined in a direction at 90 degrees with respect to the direction of lamination, a force acting in the direction of lamination, which is a direction in which the layers of the power-generating element and the collector are delaminated on the end face of the laminate, can be weakened during the machining. This reduces the risk of breakage of the battery during manufacture.

Further, for example, a method for manufacturing a battery according to an eighth aspect of the present disclosure is directed to the method according to the seventh aspect, wherein the machining includes machining the end face with a machining blade while pressing the end face of the laminate against the machining blade.

This makes it possible to cause the tissue of the collector that underwent the plastic flow to greatly sink during the machining.

Further, for example, a method for manufacturing a battery according to a ninth aspect of the present disclosure is directed to the method according to the seventh or eighth aspect, further including forming a cut surface as the end face by cutting the laminate prior to the machining.

This makes it possible to cut the end portion of the laminate, which is unlikely to function as a battery, making it possible to increase the capacitance density of the battery to be manufactured. Further, cutting the laminate into a desired size makes it also possible to increase the capacitance accuracy of the battery. Meanwhile, cutting the laminate increases the possibility of occurrence of a short circuit between the positive and negative electrodes of the power-generating element on the cur surface due to formation of burrs on the collector, collapse of the power-generating element, or other factors. This makes it possible to remove burrs on the collector, a collapsed portion of the power-generating element, or other parts by machining the cut surface formed by cutting the laminate in the foregoing manner, thus making it possible to manufacture a highly reliable battery.

The following describes embodiments of the present disclosure with reference to the drawings.

It should be noted that the embodiments to be described below each illustrate a comprehensive and specific example. The numerical values, shapes, materials, constituent elements, placement and topology of constituent elements, steps, orders of steps, or other features that are shown in the following embodiments are just a few examples and are not intended to limit the present disclosure. Further, those of the constituent elements in the following embodiments which are not recited in an independent claim are described as optional constituent elements.

Further, the drawings are schematic views and are not necessarily strict illustrations. Accordingly, for example, the drawings are not necessarily to scale. Further, in the drawings, substantially the same components are given the same reference signs, and a repeated description may be omitted or simplified.

Further, terms such as "parallel" or "perpendicular" used herein to describe inter-element relationships, terms such as "rectangle" used herein to describe the shapes of elements, and ranges of numerical values used herein are not expressions that represent only exact meanings but expressions that are meant to also encompass substantially equivalent ranges, e.g. differences of approximately several percent.

Further, in the present specification and drawings, the x axis, the y axis, and the z axis represent the three axes of a three-dimensional orthogonal coordinate system. In a case where the planimetric shape of a battery is a rectangle, the x axis and the y axis correspond to directions parallel with a first side of the rectangle and a second side orthogonal to the first side, respectively. The z axis corresponds to a direction of lamination of layers of a power-generating element and a collector.

Further, the term "direction of lamination" as used herein corresponds to a direction normal to principal surfaces of the collector and the layers of the power-generating element. Further, the term "plan view" as used herein means a case where the battery is viewed from a direction perpendicular to a principal surface of the battery or the power-generating element, unless otherwise noted. In the case of a phrase "plan view of a surface" such as "plan view of a cut surface", it means a case where the "surface" is viewed from the front.

Further, the terms "above" and "below" as used herein do not refer to an upward direction (upward in a vertical direction) and a downward direction (downward in a vertical direction) in absolute space recognition, but are used as terms that are defined by a relative positional relationship on the basis of an order of lamination in a laminated constitution. Further, the terms "above" and "below" are applied not only in a case where two constituent elements are placed at a spacing from each other with another constituent element present between the two constituent elements, but also in a case where two constituent elements touch each other by being placed in close contact with each other. In the following description, the negative side of the z axis is referred to as "below" or "lower", and the positive side of the z axis is referred to as "above" or "upper", unless otherwise noted.

### Embodiment

### Configuration

First, a configuration of a battery according to the present embodiment is described.

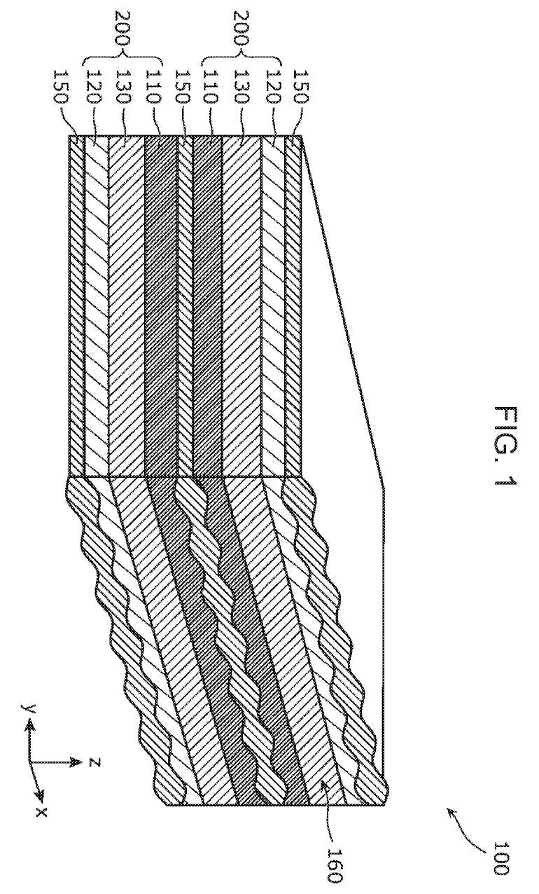

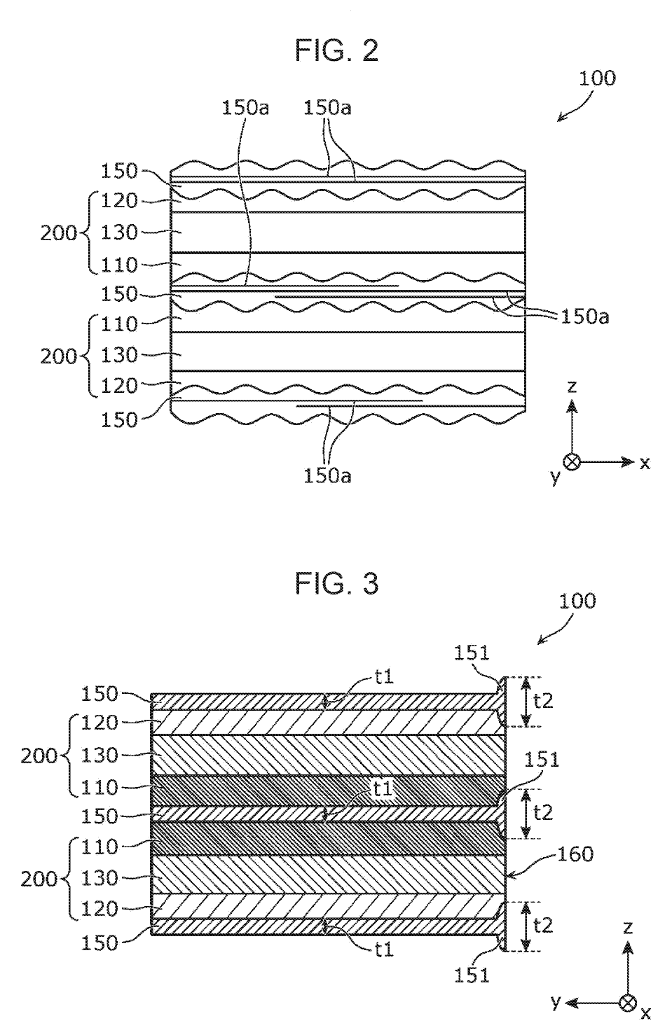

FIG. 1 is a perspective view of a battery 100 according to the present embodiment. FIG. 2 is a side view of the battery 100 according to the present embodiment. That is, FIG. 2 is a plan view of a side surface 160 of the battery 100 as seen from the front. In the illustrated example, the side surface 160 is an end face of the battery 100 that faces toward the negative side of a y-axis direction. FIG. 3 is a cross-sectional view of the battery 100 according to the present embodiment. Specifically, FIG. 3 is a cross-sectional view of the battery 100 as cut parallel to the direction of lamination (z-axis direction) and perpendicularly to the side surface 160. It should be noted that FIG. 1 omits to illustrate a linear pattern 150a shown in FIG. 2. Further, although, in the perspective view of FIG. 1 or other drawings, the side surface of each layer is diagonally shaded in the same manner as in the cross-sectional view, this does not mean that the side surface of each layer is provided with a pattern of diagonal lines.

The battery 100 includes a plurality of power-generating elements 200 and a plurality of collectors 150. In the battery 100, a collector 150 is laminated on a power-generating element 200. The battery 100 is, for example, an all-solid-state battery.

As shown in FIG. 1, the shape of the battery 100 in a plan view is, for example, a rectangle. The shape of the battery 100 is, for example, a flat cuboid. The term "flat" here means that a thickness (i.e. a length in the z-axis direction) is shorter than each side (i.e. lengths in an x-axis direction and the y-axis direction) or the maximum width of a principal surface. The shape of the battery 100 in a plan view may be another quadrangle such as a regular square, a parallelogram, or a rhombus or may be another polygon such as a hexagon or an octagon. Further, the shape of the battery 100 is, for example, a cuboid but may be another shape such as a cube, a quadrangular truncated pyramid, or a polygonal column. It should be noted that each drawing for explaining the present embodiment illustrates the thickness of each layer with exaggeration to make a layer structure of the battery 100 easier to understand.

In the illustrated example, each of the power-generating elements 200 is a minimum constituent battery and is also referred to as "unit cell". The plurality of power-generating elements 200 are laminated in such a manner as to be electrically connected in parallel. Although, in the illustrated example, the number of power-generating elements 200 that the battery 100 includes is 2, this is not intended to impose any limitation. The number of power-generating elements 200 that the battery 100 includes may be 1 or may be greater than or equal to 3. Further, in a case where the number of power-generating elements 200 that the battery 100 includes is greater than or equal to 3, all of the power-generating elements 200 that the battery 100 includes may be electrically connected in parallel, and the plurality of power-generating elements 200 may be connected in a combination of a parallel connection and a series connection.

Each of the plurality of power-generating elements 200 includes an electrode layer 110, a counter-electrode layer 120, and a solid electrolyte layer 130 located between the electrode layer 110 and the counter-electrode layer 120. Therefore, each of the plurality of power-generating elements 200 has a structure in which the electrode layer 110, the solid electrolyte layer 130, and the counter-electrode layer 120 are laminated in this order. The electrode layer 110 and the counter-electrode layer 120 each contain an active material and are also referred to as "electrode active material layer" and "counter-electrode active material layer", respectively.

The electrode layer 110 is one of positive-electrode and negative-electrode layers of the power-generating element 200. The counter-electrode layer 120 is the other of the positive-electrode and negative-electrode layers of the power-generating element 200. The following gives a description by taking as an example a case where the electrode layer 110 is the negative-electrode layer and the counter-electrode layer 120 is the positive-electrode layer. Alternatively, the electrode layer 110 may be the positive-electrode layer, and the counter-electrode layer 120 may be the negative-electrode layer.

The plurality of power-generating elements 200 are substantially identical in configuration to each other. The order of arrangement of the layers of a first power-generating element 200 is an upside down reversal of the order of arrangement of the layers of a second power-generating element 200 that is adjacent to the first power-generating element 200. That is, the plurality of power-generating elements 200 are laminated in an arrangement along the z axis while the orders of arrangement of the layers of the power-generating elements 200 are alternately interchanged. That is, adjacent power-generating elements 200 are laminated so that electrodes of the same polarity are electrically connected to each other via a collector 150.

Each of the plurality of collectors 150 functions as an electrode connector that is electrically connected to an electrode layer 110 or a counter-electrode collector that is electrically connected to a counter-electrode layer 120. On at least one principal surface of a collector 150 functioning as an electrode collector, an electrode layer 110 is laminated with no solid electrolyte layer 130 sandwiched therebetween. On at least one principal surface of a collector 150 functioning as a counter-electrode collector, a counter-electrode layer 120 is laminated with no solid electrolyte layer 130 sandwiched therebetween. In the illustrated example, a collector 150 sandwiched between adjacent power-generating elements 200 functions as an electrode collector, and the uppermost and lowermost collectors 150 function as counter-electrode collectors.

Each of the plurality of power-generating elements 200 is sandwiched between two of the plurality of collectors 150 that are adjacent to each other. Further, two of the plurality of power-generating elements 200 that are adjacent to each other are laminated with any of the plurality of collectors 150 sandwiched therebetween.

The solid electrolyte layer 130 is in contact with the electrode layer 110 and the counter-electrode layer 120. The thickness of the solid electrolyte layer 130 is, for example, greater than or equal to 5 μm and less than or equal to 150 μm.

The solid electrolyte layer 130 contains at least a solid electrolyte and may contain a binder material as needed. The solid electrolyte layer 130 may contain a solid electrolyte having lithium conductivity.

As the solid electrolyte, a publicly known material such as a lithium ion conductor, a sodium ion conductor, or a magnesium ion conductor can be used. As the solid electrolyte, for example, a solid electrolyte material such as a sulfide solid electrolyte, a halogen solid electrolyte, or an oxide solid electrolyte is used. As the sulfide solid electrolyte, a mixture of lithium sulfide (Li₂S) and diphosphorous pentasulfide (P₂S₅) is used. Further, as the sulfide solid electrolyte, a sulfide such as Li₂S-SiS₂, Li₂S-B₂S₃, or Li₂S-GeS₂ may be used, or a sulfide obtained by adding at least one of Li₃N, LiCl, LiBr, Li₃PO₄, and Li₄SiO₄ as an additive to the aforementioned sulfide may be used.

As the oxide solid electrolyte, for example, Li₇La₃Zr₂O₁₂ (LLZ), Li_{1.3}Al_{0.3}Ti_{1.7}(PO₄)₃ (LATP), or (La,Li)TiO₃ (LLTO) is used.

As the binder material, for example, elastomers are used, or an organic compound such as polyvinylidene fluoride, acrylic resin, or cellulose resin may be used.

The electrode layer 110 is placed on a principal surface of a collector 150 functioning as an electrode collector that faces the counter-electrode layer 120. The electrode layer 110 is placed opposite the counter-electrode layer 120. Although the thickness of the electrode layer 110 is, for example, greater than or equal to 5 μm and less than or equal to 300 μm, this is not intended to impose any limitation. Further, the thickness of the electrode layer 110 is, for example, greater than the after-mentioned first thickness t1 of the collector 150.

The electrode layer 110 contains at least a negative-electrode active material and may contain at least one of a solid electrolyte, a conductive aid, and a binder material as needed. As the negative-electrode active material, a publicly known material that can occlude or release (either insert and desorb or dissolve and deposit) lithium ions, sodium ions, or magnesium ions can be used. As the negative-electrode active material, in the case of a material that can desorb and insert lithium ions, for example, a carbon material such as natural graphite, artificial graphite, graphite carbon fiber, or resin baked carbon, an oxide of metallic lithium, a lithium alloy, or lithium and a transition metal element, or other materials are used.

As the solid electrolyte, the aforementioned solid electrolyte material can be used. Further, as the conductive aid, for example, an electrical conducting material such as acetylene black, carbon black, graphite, or carbon fiber is used. Further, as the binder material, the aforementioned binder material can be used.

The electrode layer 110 is fabricated by preparing a paste of paint into which the material to be contained in the electrode layer 110 were kneaded together with a solvent, spreading the paste of paint over the principal surface of the collector 150, and drying the paste of paint. For increased density of the electrode layer 110, an electrode plate including the electrode layer 110 and the collector 150 may be pressed after the drying.

The counter-electrode layer 120 is placed on a principal surface of a collector 150 functioning as a counter-electrode collector that faces the electrode layer 110. Although the thickness of the counter-electrode layer 120 is, for example, greater than or equal to 5 μm and less than or equal to 300 μm, this is not intended to impose any limitation. Further, the thickness of the counter-electrode layer 120 is, for example, greater than the after-mentioned first thickness t1 of the collector 150.

The counter-electrode layer 120 contains at least a positive-electrode active material and may contain at least one of a solid electrolyte, a conductive aid, and a binder material as needed.

As the positive-electrode active material, a publicly known material that can occlude or release (either insert and desorb or dissolve and deposit) lithium ions, sodium ions, or magnesium ions can be used. As the positive-electrode active material, in the case of a material that can desorb and insert lithium ions, for example, a lithium cobalt oxide complex oxide (LCO), a lithium nickel oxide complex oxide (LNO), a lithium manganese oxide complex oxide (LMO), a lithium-manganese-nickel complex oxide (LMNO), a lithium-manganese-cobalt complex oxide (LMCO), a lithium-nickel-cobalt complex oxide (LNCO), a lithium-nickel-manganese-cobalt complex oxide (LNMCO), or other materials are used.

As the solid electrolyte, the aforementioned solid electrolyte material can be used. As the conductive aid, the aforementioned conductive aid can be used. Further, as the binder material, the aforementioned binder material can be used.

The counter-electrode layer 120 is fabricated by preparing a paste of paint into which the material to be contained in the counter-electrode layer 120 were kneaded together with a solvent, spreading the paste of paint over the principal surface of the collector 150, and drying the paste of paint. For increased density of the counter-electrode layer 120, a counter-electrode plate including the counter-electrode layer 120 and the collector 150 may be pressed after the drying.

In the present embodiment, the electrode layer 110, the counter-electrode layer 120, and the solid electrolyte layer 130 are maintained in a parallel plate state. This makes it possible to reduce the occurrence of a crack or a collapse due to bending. It should be noted that the electrode layer 110, the counter-electrode layer 120, and the solid electrolyte layer 130 may be smoothly bent together.

In the power-generating element 200, for example, in a plan view, the collector 150, the electrode layer 110, the counter-electrode layer 120, and the solid electrolyte layer 130 are the same in shape and size as one another and have their contours in conformance with one another when seen from the z-axis direction.

The electrode layer 110 or the counter-electrode layer 120 is in contact with the principal surface of the collector 150. It should be noted that the collector 150 may include a collector layer that is a layer, provided in a portion touching the electrode layer 110 or the counter-electrode layer 120, that contains an electrical conducting material.

As a material of the collector 150, a publicly known material can be used. For example, as the material of the collector 150, copper, aluminum, nickel, iron, stainless steel, platinum, gold or a foil-like, plate-like, or net-like member composed of an alloy of two or more of these metals is used. In the example shown in FIGS. 1 to 3, the collector 150 is constituted by one sheet of metallic foil. It should be noted that the collector 150 may have a multilayer structure of a plurality of collecting layers composed of a plurality of sheets of metallic foil or other materials. In this case, the plurality of connecting layers are laminated either directly or with an intermediate layer sandwiched therebetween.

The collector 150 has a projecting portion 151 that projects toward both sides of the direction of lamination at an end portion of the collector 150 beside the side surface 160 of the battery 100. The projecting portion 151 is exposed at the side surface 160. At least part of the projecting portion 151 is buried in the power-generating element 200 and overlaps the power-generating element 200 when seen from the direction of lamination. In the illustrated example, the whole of the projecting portion 151 is buried in the power-generating element 200 and overlaps the power-generating element 200 when seen from the direction of lamination. The projecting portion 151 covers part of the power-generating element 200, specifically part of the electrode layer 110 or part of the counter-electrode layer 120 at the side surface 160. The projecting portion 151 is provided at the whole end portion of the collector 150 beside the side surface 160, for example, along the x-axis direction. Portions of the collector 150 other than the projecting portion 151 are, for example, uniform in thickness. A central part of the collector 150 may be smallest in thickness.

Further, by having the projecting portion 151, the collector 150 has its end portion made thick. Specifically, in an area of overlap between the collector 150 and the power-generating element 200 as seen along the direction of lamination, the ratio of a second thickness t2 to a first thickness t1 is greater than or equal to 101% and less than or equal to 200%. The first thickness t1 is the thickness of a central part of the collector 150. The second thickness t2 is the maximum thickness of the collector 150 at the end portion thereof beside the side surface 160. This causes the end portion of the collector 150 to sink into the electrode layer 110 or the counter-electrode layer 120 to cover an end face of the power-generating element 200, making it possible to reduce the risk of collapse of the electrode layer 110 or the counter-electrode layer 120 thus covered with the end portion of the collector 150. This makes it possible to reduce the risk of a short circuit between the electrode layer 110 or the counter-electrode layer 120 due to collapse. Further, since the second thickness t2 is less than or equal to 200% of the first thickness t1, it becomes hard for the collector 150 to make contact with both the electrode layer 110 and the counter-electrode layer 120 of one power-generating element 200, making it possible to reduce the risk of a short circuit between the electrode layer 110 and the counter-electrode layer 120 by the collector 150. This makes it possible to enhance the reliability of the battery 100. The second thickness t2 can also be said to be the maximum thickness (maximum length in the direction of lamination) of a portion of the projecting portion 151 that overlaps the power-generating element 200 when seen along the direction of lamination.

The first thickness t1 is, for example, greater than or equal to 5 μm and less than or equal to 100 μm. Further, the second thickness t2 is, for example, greater than the first thickness t1 by 0.2 μm or greater and 5 μm or less. This makes it possible to enhance the effect of improvement in reliability by the ratio of the second thickness t2 to the first thickness t1.

Further, as shown in FIGS. 1 to 3, the end portion of the collector 150 beside the side surface 160 spreads further toward both sides of the direction of lamination than the central part of the collector 150 to become thick. Even in a case where the second thickness t2 is greater than the first thickness t1, this makes it harder for the collector 150 to make contact with both the electrode layer 110 and the counter-electrode layer 120 of one power-generating element 200, making it harder for the electrode layer 110 and the counter-electrode layer 120 to become short-circuited with each other via the collector 150. It should be noted that a portion of the projecting portion 151 that projects upward from the uppermost surface of the battery 100 and a portion of the projecting portion 151 that projects downward from the lowermost surface of the battery 100 may be removed by grinding or other processes.

Further, as shown in FIGS. 1 and 2, in a case where the collector 150 is seen from the end portion of the collector 150 beside the side surface 160, i.e. in a plan view of the side surface 160, the length of an end face of the collector 150 in the direction of lamination is not constant. That is, the thickness (length in the direction of thickness) of the projecting portion 151 is not constant. With a thick portion of the projecting portion 151 serving as a catch, this makes it hard for the collector 150 and the power-generating element 200 to slide in a direction perpendicular to the direction of lamination, making it possible to reduce the risk of delamination of the collector 150 and the power-generating element 200. Further, in a plan view of the side surface 160, three are depressions and projections, e.g. waves, at a boundary between the collector 150 and the power-generating element 200. The boundary between the collector 150 and the power-generating element 200 is specifically a boundary between the collector 150 and the electrode layer 110 or a boundary between the collector 150 and the counter-electrode layer 120.

The side surface 160 of the battery 100 is, for example, a machined surface subjected to a finishing machining process. The shape of the end portion of the collector 150 beside the side surface 160 is formed by performing the machining process. The machining process will be described in detail later.

In a case where the collector 150 is seen from the end portion of the collector 150 beside the side surface 160, i.e. in a plan view of the side surface 160, the end face of the collector 150 is provided with a linear pattern 150a, which is an example of a linear depressed portion or raised portion. The end face of the collector 150 constitutes part of the side surface 160. The linear pattern 150a is, for example, a linear minute depression or projection on the end face attributed to the machining process. In the example shown in FIG. 2, the end face of the collector 150 is provided with a plurality of the linear patterns 150a. The plurality of linear patterns 150a may be a mixture of depressions and projections. The linear pattern 150a forms an angle of 90 degrees with respect to the direction of lamination. The angle of 90 degrees means an angle of substantially 90 degrees, with a possible error of 5% or less. Providing the end face of the collector 150 with the linear pattern 150a causes a terminal to engage with the linear pattern 150a in connecting the terminal to the end face and makes it hard for the terminal to become misaligned in the direction of lamination, making it possible to reduce the risk of a short circuit between the electrode layer 110 and the counter-electrode layer 120 via the terminal.

On the side surface 160, for example, the end face of the collector 150 and a portion of the end face of the power-generating element 200 not covered with the collector 150 are flush with each other with no level difference therebetween. On the side surface 160, the collector 150 may project slightly further than the power-generating element 200.

### Method for Manufacturing Battery

The following describes a method for manufacturing a battery 100 according to the present embodiment.

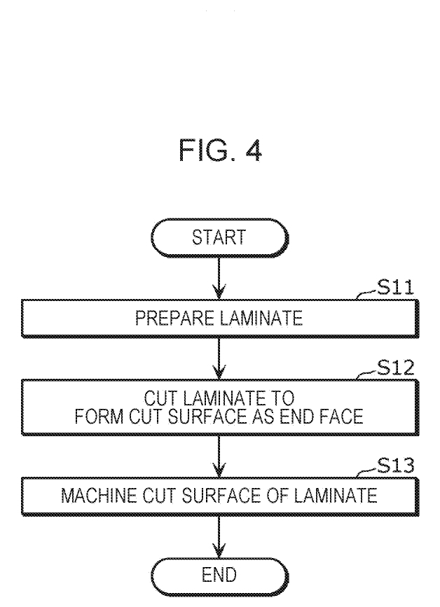

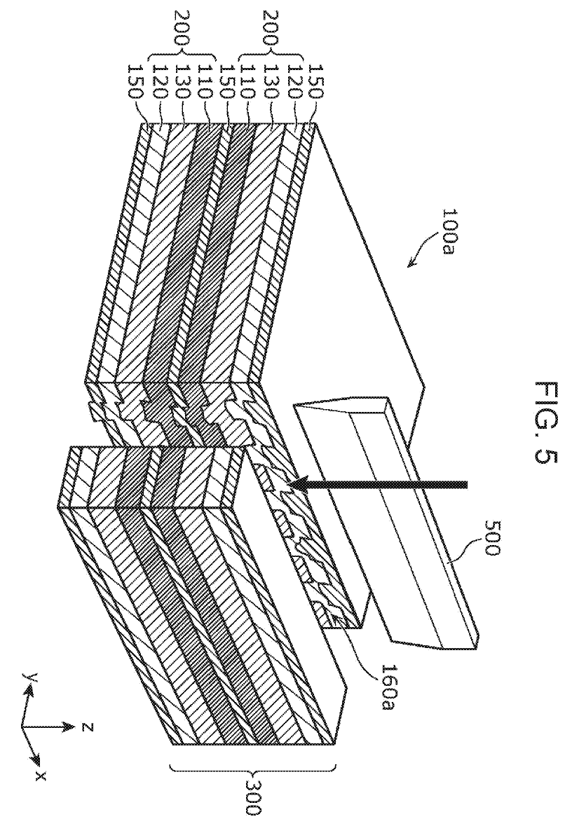

FIG. 4 is a flow chart showing an example of the method for manufacturing a battery 100 according to the present embodiment. The following method for manufacturing a battery 100 is merely an example, and any manufacturing method other than the following manufacturing method that makes it possible to manufacture a battery 100 may be used.

First, a laminate 300 in which a power-generating element 200 and a collector 150 are laminated is prepared (step S11). Then, a cut surface 160a is formed by cutting the laminate 300 (step S12).

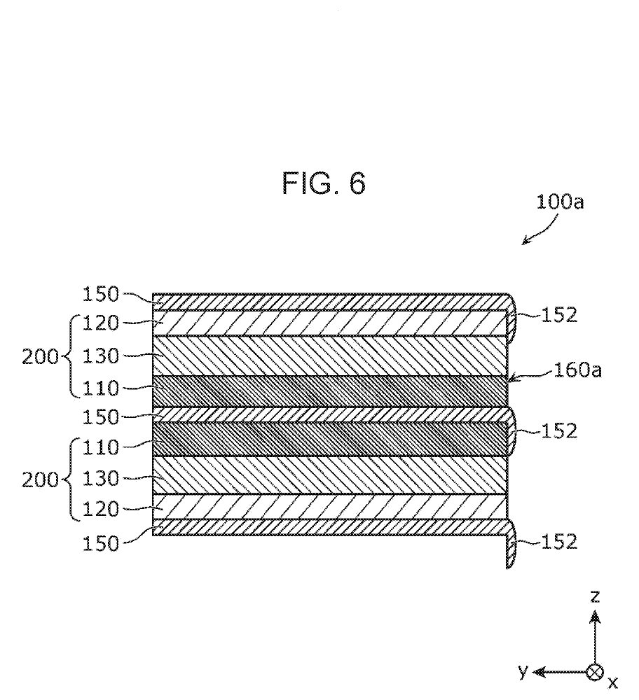

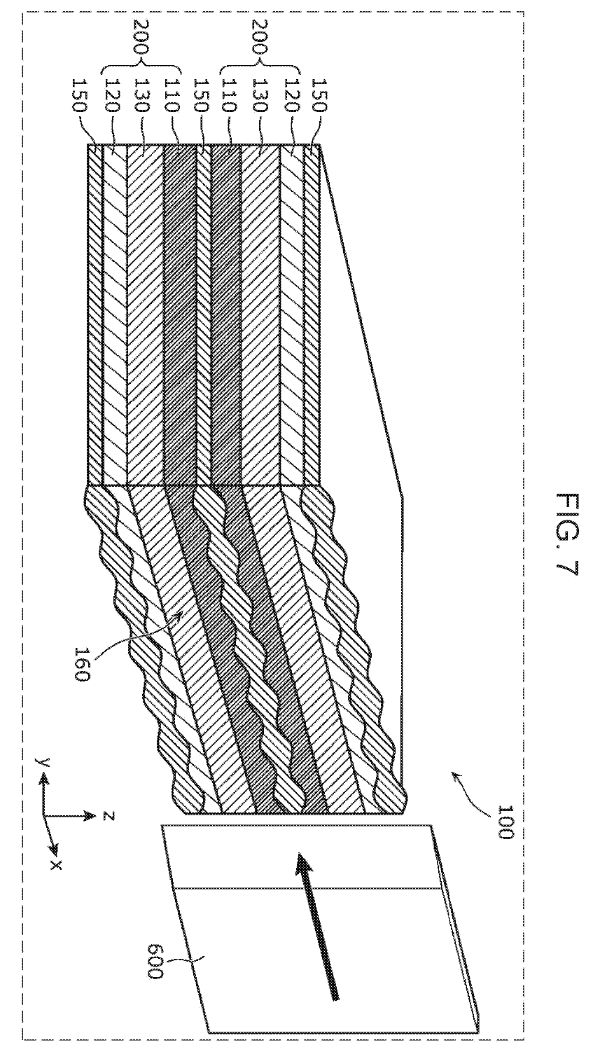

FIG. 5 is a perspective view showing a state that follows the cutting of the laminate 300. FIG. 6 is a cross-sectional view of a laminate 100a left by cutting the laminate 300. FIG. 6 is a cross-sectional view of the laminate 100a as cut parallel to the direction of lamination (z-axis direction) and perpendicularly to the cut surface 160a.

As shown in FIG. 5, the laminate 300 has a plurality of the power-generating elements 200 and a plurality of the collectors 150. The laminated constitution and order of lamination of the laminate 300 is the same as those of the battery 100 described above. The laminate 300 prepared in step S11 has the laminated constitution and the order of lamination shown in FIG. 5. The laminate 300 used is formed, for example, by laminating coated plates obtained by coating the collectors 150 with materials of the layers.

In step S12, as shown in FIG. 5, the cut surface 160a is formed by cutting the laminate 300 in such a manner as to cut the plurality of power-generating elements 200 and the plurality of collectors 150 en bloc. Therefore, the cutting in the step S12 includes cutting the laminate 300 along the direction of lamination at such a position as to pass through two, upper and lower, principal surfaces of the laminate 300.

Further, the cutting in step S12 includes cutting the laminate 300, for example, by subjecting the laminate 300 to shearing work with a cutting blade 500. In the example shown in FIG. 5, the laminate 300 is cut in such a manner than the cutting blade 500 advances along the direction of lamination from above a principal surface of the laminate 300. That is, when based on the laminate 300, the cutting blade 500 passes through the two, upper and lower, principal surfaces of the laminate 300 and moves in a direction parallel to the direction of lamination of the laminate 300. Although the cutting of the laminate 300 includes, for example, moving the cutting blade 500, the cutting of the laminate 300 may include moving the laminate 300. It should be noted that when based on the laminate 300, the cutting blade 500 may pass through the two, upper and lower, principal surfaces of the laminate 300 and move in a direction at an angle to or in a direction perpendicular to the direction of lamination of the laminate 300.

By cutting the laminate 300, the laminate 100a, which has the cut surface 160a as an end face, is formed. In step S12, an end portion of the laminate 300 may be cut off by the cutting of the laminate 300, or the laminate 300 may be divided into a plurality of the laminates 100a.

The layers of the power-generating element 200 are crushed by the cutting of the laminate 300, with the result that the electrode layer 110, the counter-electrode layer 120, and the solid electrolyte layer 130 collapse. Further, as shown in FIG. 6, a sagging portion 152 that causes a short circuit between the electrode layer 110 and the counter-electrode layer 120 is formed at an end portion of the collector 150 beside the cut surface 160a of the laminate 100a. The sagging portion 152 is, for example, a burr or other fins and is formed by tensile stress being applied to the end portion of the collector 150 by shearing. The sagging portion 152, which is formed by the cutting of the laminate 300, is not buried in an end face of the power-generating element 200 but extends in the direction of lamination along the end face of the power-generating element 200. The collector 150 may be formed with the sagging portion 152 extending by 5 μm or longer in the direction of lamination. Further, at the end portion of the collector 150, the sagging portion 152 extends only unidirectionally in the direction of lamination. The direction in which the sagging portion 152 extends is the direction in which the cutting blade 500 advances relative to the laminate 300. In the laminate 100a, the sagging portion 152 and the collapse of the electrode layer 110, the counter-electrode layer 120, and the solid electrolyte layer 130 increase the possibility of occurrence of a short circuit between the electrode layer 110 and the counter-electrode layer 120. Therefore, in the present embodiment, the sagging portion 152 and the collapsed portions of the electrode layer 110, the counter-electrode layer 120, and the solid electrolyte layer 130 are removed by the after-mentioned machining process.

Next, as the machining process, the cutting surface 160a of the laminate 100a is machined (step S13). In so doing, an end face of each layer of the power-generating element 200 and the whole of an end face of the collector 150 on the cut surface 160a are machined en bloc. The battery 100 thus obtained has a machined surface formed as a side surface 160. The machining process may be followed by grinding and/or cleaning of the side surface 160.

FIG. 7 is a perspective view for explaining the machining process. FIG. 7 shows a battery 100 formed by machining the cut surface 160a of the laminate 100a. It should be noted that FIG. 7 omits to illustrate the linear pattern 150a shown in FIG. 2.

Unlike the cutting, the machining in step S13 is a process of scraping off a surface by a slight thickness. The thickness of a portion scraped off by the machining is less than or equal to 10 μm. Meanwhile, in the cutting in step S12, even in a case where the end portion of the laminate 300 is cut off, the thickness of a portion that is cut off is greater than 10 μm and is, for example, greater than or equal to 1 mm. Further, the cutting in step S12 and the machining in step S13 are executed by using different apparatuses.

In the machining process, the cut surface 160a of the laminate 100a is machined with a machining blade 600 in a direction at 90 degrees with respect to the direction of lamination to form, as the side surface 160, a machined surface subjected to the machining process. The angle of 90 degrees means an angle of substantially 90 degrees, with a possible error of 5% or less. As the machining blade 600, for example, a metal blade such as a razor blade or a ceramic blade is used. Further, the machining blade 600 is, for example, a single-edged blade having an edge put on only one side. The machining blade 600 is used, for example, in such an orientation that a side face of the single-edged blade not given a sharpening angle faces the cut surface 160a.

For example, gradually increasing the depth of machining by the machining blade 600 after fixing the machining blade 600 so that the cut surface 160a of the laminate 100a can move along the machining blade 600 in a direction at 90 degrees with respect to the direction of lamination causes the machining blade 600 to cut into the cut surface 160a of the laminate 100a. In this way, the cut surface 160a is machined with the machining blade 600 while the cut surface 160a of the laminate 100a is pressed against the machining blade 600. It should be noted that the surface of the machining blade 600 that faces the cut surface 160a does not need to be parallel to the cut surface 160a as long as the edge of the machining blade 600 is pressed against the cut surface 160a and advances along the cut surface 160a in a direction at 90 degrees with respect to the direction of lamination. For example, when the edge of the machining blade 600 is pressed against the cut surface 160a, the surface of the machining blade 600 that faces the cut surface 160a may be inclined with respect to the cut surface 160a.

During the machining of the cut surface 160a, such a minute plastic flow occurs in the tissue of the collector 150 that the tissue of the collector 150 near the cut surface 160a escapes in the direction of lamination. This causes the end portion of the collector 150 to project in the direction of lamination to form a projecting portion 151, causing the end portion of the collector 150 to become greater in thickness. Further, the tissue of the collector 150 that underwent the plastic flow sinks into the end face of the power-generating element 200. This makes it hard for the tissue the collector 150 that underwent the plastic flow to grow in the direction of lamination. Further, with the machining blade 600 pressed against the cut surface 160a, the sinking of the tissue of the collector 150 that underwent the plastic flow can be increased. There tend to be fluctuations in the minute plastic flow of the tissue of the collector 150 caused by the advancing of the machining blade 600, and a boundary between the collector 150 and the power-generating element 200 is not straight, with the result that winding depressions and projections are formed at the boundary. In this way, the collector 150 is formed with an end structure such as the projecting portion 151 beside the side surface 160 of the collector 150. Unlike the sagging portion 152, which is formed by the cutting in step S12, the projecting portion 151 extends toward both sides of the direction of lamination and therefore is unlikely to excessively increase in length in the direction of lamination, making it also possible to reduce the occurrence of a short circuit between the electrode layer 110 and the counter-electrode layer 120. It should be noted that in a case where the projecting portion 151 does not sink into the power-generating element 200, the projecting portion 151 may be pressed against the power-generating element 200 to sink into the power-generating element 200.

Further, since the cut surface 160a is machined in a direction at 90 degrees with respect to the direction of lamination, a force acting in the direction of lamination, which is a direction in which the layers of the power-generating element 200 and the collector 150 are delaminated on the cut surface 160a, can be weakened during the machining. This reduces the risk of breakage of the battery 100 during manufacture.

Further, by machining the cut surface 160a in a direction at 90 degrees with respect to the direction of lamination, a linear pattern 150a (see FIG. 2) forming an angle of 90 degrees with respect to the direction of lamination can be formed as a trace of machining on the end face of the collector 150. Even in a case where a trace of machining is formed on the end face of the collector 150, a force acting on the collector 150 in the formation of the trace of machining comes into a direction at 90 degrees with respect to the direction of lamination, so that a force is unlikely to act in the direction of lamination, which is a direction in which the power-generating element 200 and the collector 150 are delaminated.

The foregoing manufacturing method makes it possible to achieve a battery 100 of the aforementioned structure, making it possible to manufacture a highly reliable battery 100. Further, performing the machining process makes it possible to make the end face positions of the layers of the battery 100 uniform and prevent the electrode layer 110 and the counter-electrode layer 120 from protruding from the side surface 160 of the battery 100. This makes it possible to reduce the risk of a short circuit due to contact between the electrode layer 110 and the counter-electrode layer 120.

Further, the end portion of the laminate 300 formed by coating is unlikely to function as a battery, and cutting the end portion of the laminate 300 makes it possible to increase the capacitance density of the battery 100 to be manufactured. Further, cutting the laminate 300 into a desired size makes it also possible to increase the capacitance accuracy of the battery 100. Meanwhile, cutting the laminate 300 increases the possibility of occurrence of a short circuit between the electrode layer 110 and the counter-electrode layer 120 due to the sagging portion 152 and the collapse of the electrode layer 110, the counter-electrode layer 120, and the solid electrolyte layer 130. Machining the cut surface 160a formed by cutting the laminate 300 makes it possible to remove the sagging portion 152 and the collapsed portions of the electrode layer 110, the counter-electrode layer 120, and the solid electrolyte layer 130, thus making it possible to manufacture a highly reliable battery 100.

In the foregoing method for manufacturing a battery 100, the cutting of the laminate 300 in step S12 is not essential, but for example, the machining process in step S13 may be performed on an end face of the laminate 300.

Further, in manufacturing the battery 100, for example, the projecting portion 151 may be formed by causing the collector 150 to protrude slightly further from the side surface 160 than the power-generating element 200 and stretching the protruding portion of the collector 150 in the direction of lamination to press it against the power-generating element 200. In this case, step S12 and step S13 do not need to be executed.

### Other Embodiments

While the foregoing has described a battery and a method for manufacturing a battery according to the present disclosure with reference to embodiments, the present disclosure is not intended to be limited to these embodiments. Applications to the embodiments of various modifications conceived of by persons skilled in the art and embodiments constructed by combining constituent elements in different embodiments are encompassed in the scope of the present disclosure without departing from the spirit of the present disclosure.

For example, although, in the foregoing embodiment, only an end portion of the collector 150 beside one side surface 160 of the battery 100 is thicker than the central part, this is not intended to impose any limitation. An end portion of the collector 150 beside a side surface of the battery 100 other than the side surface 160 may also be provided with a projecting portion 151 and be thicker than the central part as is the case with the end portion of the collector 150 beside the side surface 160.

Further, although the foregoing embodiment has illustrated the formation of one side surface 160 of the battery 100, a side surface of the battery 100 other than the side surface 160 may also be formed by a method that is similar to that by which the side surface 160 is formed. For example, all side surfaces of the battery 100 may be machined surfaces formed by the foregoing manufacturing method.

Further, although, in the foregoing embodiment, the battery 100 is configured such that the plurality of power-generating elements 200 are laminated in such a manner as to be electrically connected in parallel, this is not intended to impose any limitation. The plurality of power-generating elements 200 may be laminated in such a manner as to be electrically connected in series. In this case, the plurality of power-generating elements 200 may be laminated in an arrangement along the z axis so that the order of arrangement of the layers of one power-generating element 200 is the same as the order of arrangement of the layers of another power-generating element 200. That is, adjacent power-generating elements 200 are laminated so that electrodes of different polarities are electrically connected to each other. Further, a collector 150 located between the adjacent power-generating elements 200 functions as a bipolar collector.

Further, each of the foregoing embodiments can be subjected to various alterations, substitutions, additions, omissions, or other changes within the scope of the claims or the scope of equivalents thereof.

A battery according to the present disclosure can be utilized as a battery for an electronic device, an electric appliance, an electric vehicle, or other pieces of equipment.

What is claimed is:

1. A battery comprising:
a power-generating element; and
a collector laminated on the power-generating element,
wherein in an area of overlap between the collector and the power-generating element as seen along a direction of lamination of the power-generating element and the collector, a ratio of a second thickness to a first thickness is greater than or equal to 101% and less than or equal to 200%, the first thickness being a thickness of a central part of the collector, the second thickness being a maximum thickness of the collector at an end portion thereof.

2. The battery according to claim 1, wherein the second thickness is greater than the first thickness by 0.2 μm or greater and 5 μm or less.

3. The battery according to claim 1, wherein in a case where the collector is seen from the end portion, a length of an end face of the collector in the direction of lamination is not constant.

4. The battery according to claim 1, wherein the end portion of the collector spreads further toward both sides of the direction of lamination than the central part of the collector.

5. The battery according to claim 1, wherein
in a case where the collector is seen from the end portion, the end face of the collector is provided with a linear depressed portion or raised portion, and
the linear depressed portion or raised portion forms an angle of 90 degrees with respect to the direction of lamination.

6. The battery according to claim 1, wherein the power-generating element includes a positive-electrode layer, a negative-electrode layer, and a solid electrolyte layer located between the positive-electrode layer and the negative-electrode layer.

7. A method for manufacturing a battery, the method comprising:
preparing a laminate in which a power-generating element and a collector are laminated; and
machining an end face of the laminate in a direction at 90 degrees with respect to a direction of lamination of the power-generating element and the collector.

8. The method according to claim 7, wherein the machining includes machining the end face with a machining blade while pressing the end face of the laminate against the machining blade.

9. The method according to claim 7, further comprising forming a cut surface as the end face by cutting the laminate prior to the machining.
